(19) United States
(12) Patent Application Publication
(10) Pub. No.: US 2006/0138228 A1
(43) Pub. Date: Jun. 29, 2006

(54) Recording writing movements

(76) Inventors: David Sanders, Portsmouth, Hants (GB); Giles Tewkesbury, Portsmouth, Hants (GB); Stephen Urwin-Wright, Cranleigh Surrey (GB); William Power, Cranleigh Surrey (GB); Henry Powell, Cranleigh, Surrey (GB); Robert Patrick Powell, Cranleigh Surrey (GB)

Correspondence Address: FISH & RICHARDSON PC, P.O. BOX 1022, MINNEAPOLIS, MN, 55440-1022, US

(21) Appl. No.: 10/529,075

(22) PCT Filed: Sep. 29, 2003
(86) PCT No.: PCT/GB03/04213

§ 371 Date: Sep. 15, 2005

(30) Foreign Application Priority Data
Oct. 4, 2002 (GB) 0223074.6

(51) Int. Cl. G06K 7/00

(52) U.S. Cl. 235/435

(57) ABSTRACT

The writing motion of a hand, pen or stylus is reported via a digital communications link, such reporting taking the form of packets of digital data, such packets containing position information, such packets also containing real-time information. Apparatus is described for recording the movement of a stylus during handwriting, for example in the execution of a handwritten signature. The apparatus comprises digitizer means, capable of sensing the position of a stylus, and defining an active signing area. A control circuit is capable of sampling at least orthogonal X and Y coordinates, in the plane of the active signing area, of a stylus in proximity to the digitizer means, and of then transmitting information regarding said coordinates together with real-time information via a digital communications link. The real-time information is represented either as a sequential number or in absolute form as clock-time.

### BACKGROUND

This invention relates to recording writing movements, for example during the execution of a handwritten signature.

Digitizers—that is, devices for measuring and transmitting to a computer system the movement of a stylus—have been under development for some decades. The majority consist of an opaque, flat tablet and a specially constructed stylus. In the main, they have been intended for graphical applications, where a mouse does not always provide sufficient ease or precision of movement Therefore, the principal design goal has been the accurate measurement of the position of the stylus tip.

It has long been recognized that such digitizers can be used to capture signatures. The measurement of signing behaviour—signature biometrics—has developed in tandem with the development of digitizer hardware. Early systems were able to measure only the path followed by the pen tip, and the approximate timing of its motion. Since digitizers typically report the position of the pen tip at a regular interval, quite accurate information could be gained as to the pattern of velocity change for each individual. As the Fil-Seifer and Kimia Survey of Approaches to Signature Verification (http://www.lems.brown.edu/˜dfs/background htm) demonstrates, dynamic factors are of central importance in the art of signature biometrics.

With further development in digitizer hardware, other signing characteristics could be observed. Some digitizers, for example, were able to measure the amount of pressure brought to bear on the stylus tip. Others exploited a technique similar to that outlined by Dhawan (U.S. Pat. No. 4,771,138) and used multiple sensory layers in order to construct a 3-dimensional image of the movement of the pen. Others used a single-layer sensor capable of detecting multiple electromagnetic resonators, as taught by Fukuzaki Yashuhiro (U.S. Pat. No. 6,020,849). Such devices can detect in-air movement of the stylus when in proximity with the digitizer surface, the orientation and angle of elevation of the stylus, and even the degree of rotation of the stylus barrel (for example, see U.S. Pat. No. 6,433,781). Using such devices, students of signature dynamics were thus able to observe a wider range of characteristic patterns, and use this information to build up a more comprehensive picture of individual signing behaviour.

With the maturation of signature biometrics as a science, many practical applications have been envisaged, e.g. the signing of electronic forms and documents, and the protection of private personal information on computer systems.

However, using an opaque digitizer is an unfamiliar experience for most people, accustomed as they are to writing with a normal pen, and seeing the traces of ink on paper. At first, the experience of using opaque digitizers is disorienting, which will often disrupt their normal signing behaviour. Various manufacturers have therefore incorporated flat display surfaces into the digitizer tablet, and have developed systems whereby “electronic ink” can be made to appear on the display when the stylus moves in contact with the surface. (See, for example, the PenWare apparatus described by Llavanya et al. in U.S. Pat. No. 6,193,152.) Unfortunately, however, most suitable displays are so designed that their control circuitry interferes with the signals transmitted and received by the electrode layers, thus reducing accuracy.

To date signature capture devices have typically been designed with more consideration to the internal economy of construction than to the ergonomics of the signing process. Signing is an oft-repeated, highly rehearsed activity the naturalness of which necessitates a familiar environment Any element of strangeness has a sharply disruptive effect. All too many current signature capture devices, even where they offer “electronic ink” feedback, have ungainly contours that provide little or no support for the signatory's hand. Similarly, current devices do not address the existing problem that a slippery sensation when writing with an unfamiliar instrument upon a smooth glass or plastic surface is initially disturbing for those used to writing with a pen on paper.

Currently available systems employ digitizers to report the position of the stylus at a regular frequency (typically 100-200 Hz). These reports are transmitted via a serial link to the host computer, where they are stored for later analysis. Prevailing computer operating system design dictates that digitizer information is handled by a standard input subsystem dedicated to pointing devices.

Computer input systems for pointing devices are generally directed to determining the XY position of a mouse, although there is usually provision for the kind of supplementary data, e.g. pressure, that a digitizer will provide. Such systems will typically eliminate duplicate reports; so, for example, if the stylus were to remain perfectly still for half a second, approximately 50 reports would be eliminated as duplicates. Elimination of duplicates in this way makes it impossible to determine stylus speed over the whole signature with any accuracy.

The signature capture application on the host computer may seek to alleviate this problem by applying timestamps to the incoming data as soon as they are received through the input subsystem. In practice, however, the signature capture application can only obtain the digitizer data when permitted by the process dispatcher of the operating system. Other, higher priority processes may impose a considerable delay, thus inducing distortions.

In summary, because modern operating systems tend to handle digitizer data as a low-priority input of which only the XY component is accorded significance, traditional signature capture devices are not capable of delivering sufficiently accurate timing information to meet the requirements of dynamic signature analysis.

One further unresolved concern relates to security. Given that an individual's signing behaviour may be used for the purposes of personal authentication, it is clearly undesirable that related data be intercepted Current signature capture devices do not encrypt the output data stream, owing to the demands of the host computer input systems. It is therefore a simple matter to intercept the data stream and use it for replay attacks.

Finally, stylus-sensitive devices according to the present art do not provide a means for verifying the correct calibration and operation of the unit. Therefore, the data they provide gives no way to establish whether the device is working correctly. This renders them unsuitable for providing data that would be admissible as evidence in forensic proceedings.

The present invention, in its several aspects has arisen from our work in seeking to provide practical embodiments of signature capture device that offer the signatory an experience as similar as possible to the familiar process of signing with an ordinary pen on paper, while at the same time providing to signature analysis systems data that are more complete and accurate than can be obtained from traditional devices.

### SUMMARY OF THE INVENTION

In accordance with a first aspect of this invention, we provide a method of reporting the writing motion of a hand, pen or stylus via a digital communications link such reporting taking the form of packets of digital data, such packets containing position information, such packets also containing real-time information.

By “digital communications link” we mean any form of link capable of transmitting data, whether serial, parallel, or multiplex. The link may include networks such as an Ethernet or networks operating on a TCP/IP protocol, including Intranets and the Internet.

The real-time information preferably takes the form of a digital encoding of the minute, second and fraction thereof either separately or in combination. Alternatively, the real-time information may take the form of a sequential number.

As will become clear from the description below, provision of real-time information together with the position information, something not previously done in this art, provides significant advantages over a broad range of different forms of writing detection.

The method is applicable to the reporting of signatures from a plurality of peripheral stations to a host, in which case, the packets of data preferably include an identification of the specific peripheral station employed for each signature.

In a second and alternative aspect of this invention, we provide an apparatus for recording the movement of a stylus during handwriting, for example in the execution of a handwritten signature, the apparatus comprising:
digitizer means capable of sensing the position of a stylus; and
a control circuit capable of sampling at least the X and Y coordinates of a stylus in proximity to the said digitizer means, and of then transmitting said coordinates together with real-time information via a digital communications link, such real-time information being represented either as a sequential number or in absolute form as clock-time.

Apparatus in accordance with this aspect of the invention will supply more complete and more accurate data for analysis than previous arrangements in that it incorporates real-time information in the data stream, thereby overcoming the problems introduced by computer input systems that eliminate duplicate points, lose data through insufficient buffering, or offer the data to applications in an untimely fashion.

Preferably the data is further improved by using a digitizer means, preferably in the form of a discrete digitizer module, that can detect stylus movement in the Z as well as the X and Y axes.

The term “stylus” is intended to encompass all pointing devices that are capable of being detected in apparatus for detecting writing movements. The term thus includes both conventional styli and pens, for example containing electrostatic emitters or resonators.

In our preferred arrangement, the digital communications link is provided by a serial interface serving as digital communications interface to communicate with a host. However, any other kind of digital communications interface, such as a parallel or a multiplexed interface, may be used instead.

The apparatus preferably also includes an LCD device, which may preferably be in the form of a discrete LCD module, the LCD display of which is substantially co-extensive with the digitizer module and lies substantially in the same plane. In-contact motion of the stylus can then be represented by drawing a trail of “electronic ink”, providing the signatory with a more familiar signing experience.

Previous attempts to incorporate an LCD device with the active signing area have resulted in the LCD control circuitry tending to interfere with the operation of the digitizer, a problem highlighted by Schomacher et al. as long ago as 1995 in their report on the Esprit MIAMI project, but never previously adequately solved. In one way of overcoming this problem, as described hereinbelow, the LCD module is designed so that the driver circuitry is offset to the side of, and preferably above or below (below in the illustrated embodiment) the active signing area. While, at first sight, this might seem an elementary solution, in reality those skilled in this art have hitherto retained conventional LCD geometry and pursued alternative strategies in effort to avoid the problem (see, for example, Ballare et al. in U.S. Pat. No. 6,124,848). This simple step, believed novel in its own right, may significantly improve design and performance.

Accordingly, the invention provides, in a third alternative aspect thereof, an apparatus for recording the movement of a stylus during handwriting, for example in the execution of a handwritten signature, the apparatus comprising:
digitizer means capable of sensing the position of a stylus, the digitizer device defining a signing area;
an LCD device having an LCD display substantially coextensive with the digitizer means and lying substantially in the same plane,
   the LCD device having driver circuitry offset to the side of, and out of the plane of (preferably below), the active signing area; and
a control circuit capable of sampling at least the X and Y coordinates of a stylus in proximity to the said digitizer means.

The unnatural feel of the signing area in existing devices has long been recognized (See, for example, Chang, L., & MacKenzie, I. S., “A comparison of two handwriting recognizers for pen-based computers”, Proceedings of CASCON '94, Toronto: IBM Canada, and Schomaker et al. Ibid). In arrangements in accordance with this invention that incorporate an LCD device, the signing experience can be made to seem even more natural by providing a signing area that has a textured surface, preferably designed to provide a similar resistance to movement of the stylus tip across the surface to that of paper. This simple step, not previously used or suggested by others, to the best of Applicant's knowledge, provides a major ergonomic improvement.

Accordingly, the invention provides, in a fourth alternative aspect thereof, an apparatus for recording the movement of a stylus during handwriting, for example in the execution of a handwritten signature, the apparatus comprising:
a stylus having a tip;
digitizer means capable of sensing the position of the stylus, the digitizer device defining a signing area;
an LCD device having an LCD display substantially coextensive with the digitizer means and lying substantially in the same plane; and
a control circuit capable of sampling at least the X and Y coordinates of the tip of the stylus in proximity to the said digitizer means;
   the signing area being provided with a textured surface, the resistance of which to passage of the tip of the stylus thereacross is substantially the same as that of paper to passage of the tip of a pen or pencil thereacross.

Further ergonomic improvement can be provided by employing a digitizer means that can detect stylus movement in the Z as well as the X and Y axes, thus avoiding any necessity for the signatory to exert greater pressure than normal. The apparatus is preferably housed in a housing providing comfortable ergonomic support to both left- and right-handed signatories.

The unit may also be used by the host to display text and graphics, both in the context of signature capture and independently. This is of particular value in preferred embodiments concerned with signature capture, for security or financial transactional purposes, since it is then possible to display on the signing surface essential information about the signature, such as the time and date, the claimed identity of the signatory, and the reason for signing, for example financial details of the transaction.

Preferably, the control circuit includes logic for encrypting communications between itself and a host system, using any of the conventional encryption systems. This prevents a would-be interceptor from misappropriating signature data and re-using them for some unauthorized purpose.

The encryption key may be generated anew each day by including a random number generator in the apparatus, the generator being arranged to generate a random number encryption key automatically when connected to a source of power, the random number so generated being temporarily displayed on the apparatus and being required to be directly input into the host computer for the host computer to read the coordinate information from the apparatus.

Accordingly, the invention provides, in a fifth alternative aspect thereof a method of encrypting communication between a peripheral device and a host computer to which it may be connected, the method including generation of an encryption key for the said peripheral device by providing the peripheral device with a random number generator adapted on receipt of a pre-set signal to generate a random number encryption key for that peripheral device, the key so generated for the said peripheral device being required to be directly input into said host computer to allow the host computer to read data from said peripheral device.

Preferably, the control circuit of the apparatus is also equipped with a non-volatile memory containing a unique number by which the specific apparatus may be identified. This identifier may then be communicated to a host system and may be used to correlate signature data with self-test results, further strengthening their corroborative evidential effect In addition, the identifier may be associated with signature data and thus serve as evidence of the signatory's location.

Accordingly, the invention provides, in a sixth and further alternative aspect thereof, a system for recording handwritten signatures, comprising:
a host computer system; and
a plurality of peripheral devices, each adapted to record signatures;
each said peripheral device comprising an apparatus for recording the movement of a stylus during execution of a handwritten signature, which apparatus comprises:
   digitizer means, capable of sensing the position of a stylus; and
   a control circuit capable of sampling at least the X and Y coordinates of a stylus in proximity to the said digitizer means, and of then transmitting said coordinates together with real-time information via a digital communications link to said host computer, such real-time information being represented either as a sequential number or in absolute form as clock-time;
the control circuits of individual said peripheral devices each containing a non-volatile memory means incorporating an identifier for that peripheral device; and
each said control circuit being adapted to communicate its said identifier to said host computer together with said co-ordinates and said real-time information, whereby said host computer may identify both when and at which said peripheral device a particular signature was written.

### BRIEF DESCRIPTION OF THE DRAWINGS

The invention is hereinafter more particularly described with reference to and as shown in the accompanying drawings, in which:

FIG. 1 is a perspective view showing, somewhat schematically, the principal modules of an exemplary embodiment of apparatus constructed according to this invention;

FIGS. 2, 3 and 4 show an embodiment of the LCD module of the apparatus of FIG. 1 in respective front, side and top elevational views;

FIG. 5 shows a block circuit diagram for the modules of the apparatus of FIG. 1 and their connection to a host computer; and

FIG. 6 shows an example of a display that might be shown upon the LCD panel of the apparatus of FIGS. 1 to 6.

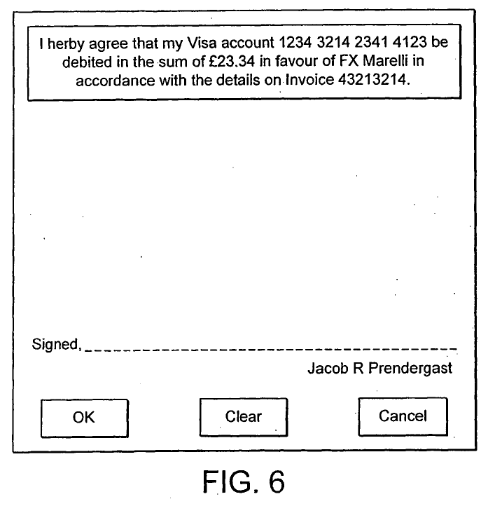

### DESCRIPTION OF PREFERRED EMBODIMENTS

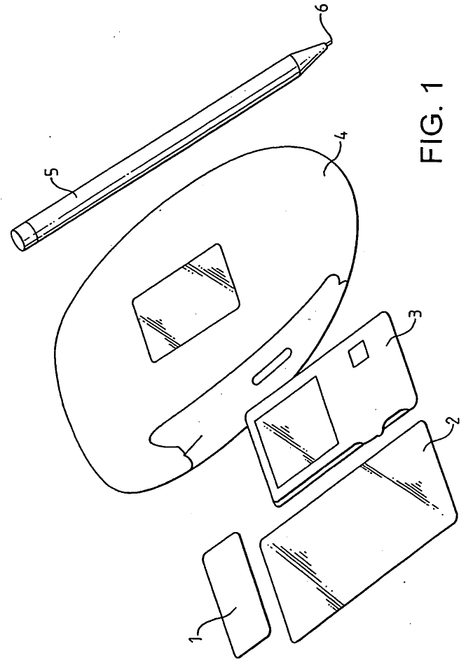

We describe herein an apparatus for accurately recording and reporting to a host computer system 20 the movements of a stylus 5 during the execution of a handwritten signature. In its exemplary embodiment, as represented in FIG. 1, the apparatus comprises a control circuit module 1, a digitizer module 2 and an LCD module 3, all housed in an ergonomic casing 4. The LCD module has an LCD display that is substantially co-extensive with the digitizer module and lies substantially in the same plane. Thus, in the illustrated embodiment, the display of LCD module 3 is located immediately above the digitizer module 2.

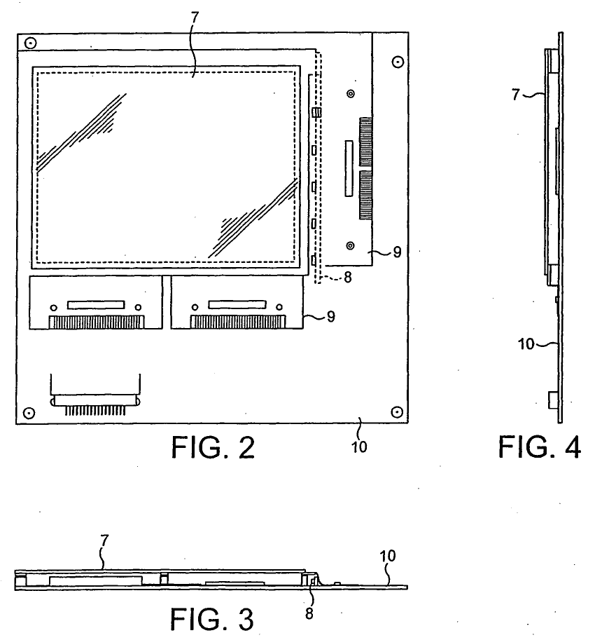

The LCD module 3, of which an exemplary embodiment is portrayed in FIGS. 2, 3 and 4, is suitably a 320×240 mm transflective graphics liquid crystal display screen 7 mounted on a printed circuit board (PCB) 10. The control and driver circuitry 9 is offset to the side and bottom of the display 7, rather than behind, as is normal. This prevents the LCD circuitry 9 from interfering with the digitizer module 2 situated immediately underneath.

The LCD module 3 incorporates a white LED backlight In the exemplary embodiment, this is arranged as an array of six LEDs 8 at the right hand side of the LCD screen 7. This provides the closest approximation to the colour and appearance of paper, thus presenting the user with as familiar an environment as possible. LEDs have the further advantage that they do not cause interference, unlike the more common CCFL tubes and EL backlights.

LCD 7 suitably offers a high density of pixels with little spacing in between Not only does this lend clarity to the signature representation, but also allows high definition graphics to be displayed. As will be described below, this allows advertisements or other useful customer-facing information to be displayed when the pad is not being used for capturing signatures. Suitable LCDs are manufactured by Ampire Co. Ltd. of Taiwan and Densitron of Japan.

As noted above digitizer circuit 2 is located substantially in the same plane as and is substantially co-extensive with the LCD display 7. Thus, in the preferred embodiment it is located immediately underneath the LCD module 3 and its active area overlaps the LCD display 7 on all four sides.

In the preferred arrangement, the circuit 2 is an electromagnetic sensor that detects the presence of a stylus 5 that generates an electromagnetic field. It has an active area of 78×58 mm with a resolution of 500 lines per inch. It captures information about the location of the stylus 5 in the X, Y and Z axes and reports this at a rate in excess of 100 data packets per second.

Suitable digitizers include the Graphire 2 manufactured by Wacom Co Ltd of Tokyo, Japan and the Genius digitizers manufactured by KYE Systems Corp. of Taipei, Taiwan.

The control circuit 1 may be located at the top or side of the digitizer circuit 2, or else be positioned underneath. It connects both to the LCD module 3 and to the digitizer circuit 2. It also connects to a host computer system 20 via a serial interface 14. Its micro controller 21 drives both the LCD module 3 and the digitizer circuit 2.

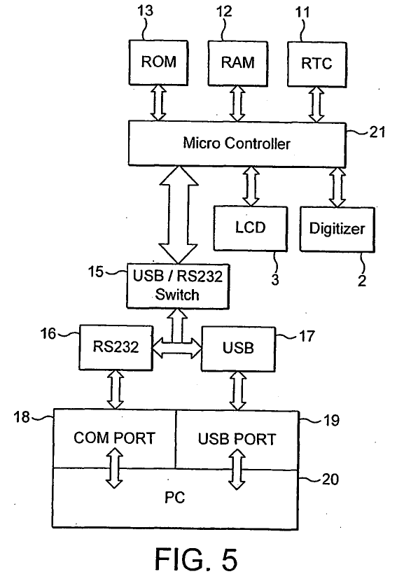

As illustrated in FIG. 5, the control circuit 1 comprises a micro controller 21, at least one non-volatile memory device 13, at least one volatile memory 12, a real-time clock 11, a serial interface 14 and supporting circuitry. It further comprises interfaces to the LCD module 3 and the digitizer circuit 2. Suitable micro controller devices include the M68HC05, M68HC08 and M68HC11 by Motorola and the 80C51 by Philips.

As illustrated in FIG. 5, the serial interface 14 connects to a switch 15 which allows the serial input and output to be switched between an RS232 port 16 and a USB port 17, either of which may be linked to the serial port 18 or the USB port 19 respectively of a host system 20. Communications via the serial interface 14 correspond to the protocols laid out in the WinTab specification (see http://www.pointing.com/), but may correspond to other similar protocols without violating the spirit of the current invention.

The described arrangement, like the great majority of peripheral devices, employs a serial interface to communicate with a host system 20. It must, however, be emphasized that any kind of digital communications interface, such as a parallel or a multiplexed interface, may be substituted without violating the spirit of the current invention. The connection may be direct or via an extended network, for example an Ethernet or a network employing the TCP/IP protocol, for example the Internet.

Upon power-up or reset, the micro controller tests the correct operation of the memory devices 12 and 13, the serial interface 14, the real-time clock 11, the LCD module 3 and the digitizer circuit 2, ensuring that they are operational and performing within specification. Thereafter, it monitors the serial interface 14, waiting for commands from a host computer 20. It also repeats the power-up test at regular intervals.

The control circuit 1 is identified by a unique identifier that is stored in a non-volatile memory (ROM) 13. This identifier is generated at the time of manufacture. The unique identifier can be stored in association with signatures captured by the device, thereby providing evidence as to the location at which the signature was executed, and making it possible to associate self-test data with the specific unit that created a given signature.

Upon receipt of a first command from the host computer 20 via the serial interface 14, the micro controller 21 performs a self-test This routine tests the operating functionality of the LCD module 3, the digitizer circuit 2 and the real-time clock 11 to ensure that they are performing in conformance with specification. A data packet is then transmitted to the host 20, indicating the results of the test. In a preferred embodiment, this data packet may contain: a code indicating the result of testing the memory devices 12 and 13; a code indicating the result of testing the real-time clock 11; a code indicating the result of testing the LCD module 3; a code indicating the result of testing the digitizer circuit 2; a code indicating the current state of the real-time clock 11; and the identifier that uniquely identifies the control circuit 1. The presence of the unique identifier lends weight to the evidential value of the data packet, since it can be used by the host computer 20 to identify signature data transmitted from the device during a signature capture operation. The self-test data packet may then be archived and later produced to demonstrate that the device was operating correctly at a material time.

Upon receipt of a second command from the host computer 20 via the serial interface 14, the control circuit 1 performs a calibration to ensure that the data appear accurately on the LCD 7 and map to the location of the stylus 5. This calibration takes into account the offset created by the different angles at which the stylus 5 is held. A set of cross hairs is displayed on the LCD 7 and the user is invited, by means of an instruction also displayed on the LCD 7, to touch the stylus 5 upon the cross-hairs. The results are then processed to calculate the angle between the position on the LCD 7 and the actual position the reading was taken on the digitizer 2. Upon completion of the calibration, a data packet may be transmitted to the host computer 20 via the serial interface 14. This calibration information can then be stored in respect of a given person, thus preserving information about the angle at which they hold the stylus 5. this calibration ensures that as the signature is written, the positions at which the electronic ink appears coincide with the users perception of the position of the stylus. In other words, the electronic ink should seemingly “flow” from the user's stylus. At the same time this calibration is communicated to the host computer to effectively calibrate the position at which the signature appears on a screen of the host.

Upon receipt of a third command, together with calibration information, received from the host computer 20 via the serial interface 14, the control circuit 1 sets the calibration of the digitizer 2 in accordance with the said calibration information. The device can thus be automatically calibrated in accordance with a specific user's stylus angle.

In another embodiment of the device, the stylus angle is measured using a second emitter or resonator in the top end of the stylus. The position of this emitter is triangulated by performing a calculation based on the X Y and Z coordinates of the signal transmitted by the second emitter or resonator. This is useful as it enables stylus angle information to be recorded in real time during the execution of a signature, adding considerable evidential value to the signature data gathered.

In another embodiment of the device, an angle of inclination measuring device built into the stylus 5 is used to measure the angle of inclination during execution of a signature.

Upon receipt of a fourth command, together with display information, received from the host computer 20 via the serial interface 14, the control circuit 1 causes the said display information to be displayed upon the LCD 7. This command would typically be used to generate a display such as the example illustrated in FIG. 4.

Upon receipt of a fifth command from the host computer 20 via the serial interface 14, the control circuit 1 continuously relays data packets containing information as to the position of the stylus 5. These data packets will contain: the X position of the stylus 5; the Y position of the stylus 5; the Z position (or pressure) of the stylus 5; and a code indicating the time at which the measurement was made. They may optionally contain information as to the angle of inclination of the stylus 5, the angle of orientation of the stylus 5, and other information sensed by the digitizer 2.

At the same time, the control circuit 1 also continuously displays the X and Y position of the stylus 5 by drawing it as a point or connecting line on the LCD 7. No direct interaction with the host system 20 is required to do this. To the signatory, this drawing action will appear as “electronic ink” and will serve to provide visual feedback, much in the same way that ink provides visual feedback when writing on paper in the normal manner.

The time code contained in each said stylus measurement data packet may be either a real-time stamp or else a sequential number stamp, which may be derived from a real time clock circuit 11 forming part of the control circuit 1. The host system 20 may select either the real-time stamp or the sequential number stamp via a sixth command transmitted on the serial interface 14. The real-time stamp may use a digital encoding of the clock time. There are various standard ways in which this may be done. For example, one well-known representation of time and date is expressed as a 32-bit number, being the number of seconds that have elapsed since midnight on 1 Jan. 1970. To this may be added a further 32-bit number expressing the number of microseconds, for finer granularity.

The time stamp overcomes problems caused by buffering information or slow or intermittent communications links between the apparatus and the signature capture software on the host system 20. It enables the movement of the pen to be more accurately recorded as a spatio-temporal phenomenon Even when some data are lost, the recording software on the host system 20 will be able to gauge how much data, and where, and thus be more reliably able to determine the speed and location of the stylus 5 at any given moment during the execution of the signature.

The provision of a time stamp to overcome communications errors is an important and novel feature of the described arrangement, and is of wider applicability than embodiments employing styli that generate electromagnetic fields. Persons skllled in this art will readily appreciate that this feature may be embodied in alternative arrangements employing touch-sensitive screen devices, opaque digitizers or other devices capable of detecting writing motion using other forms of stylus (including even a finger in the case of a touch-sensitive screen device) with a minimum of alteration to what is described in detail above. Any changes necessary will be well within the routine design skills of any such persons, without further invention being required.

In preferred arrangements, the control circuit 1 encrypts stylus position data before sending them to the host PC. This encryption serves to prevent interception of sensitive biometric information. Appropriate encryption methods include the 8-bit Triple DES and DUKPT methods, which are well known in the art.

However, in a novel and particularly secure encryption system utilising any of the above existing methods of encryption, a random number encryption key for the apparatus may be automatically generated in the apparatus upon power-up, the random number key being temporarily displayed on the apparatus and being required to be input directly into the host computer before the host can read data from the apparatus. Where the host and the signature capture apparatus are within reasonable physical distance of each other, for example in a bank or building society branch, this ensures that the day's encryption key is entered into the system without any electronic communication that might be intercepted.

Random number generators are readily available, and incorporation thereof into the apparatus will be within the normal skills of persons in this field.

The housing 4 for the above modules is designed to hold them securely and to provide a stable and comfortable environment for the execution of the signature, with a low profile similar to that of a writing pad. The LCD 7 and active signing area is positioned so that there is a large inactive border to the bottom, left and right This area is smooth and flat, functioning as a comfortable surface to support the hand during the execution of the signature. The LCD 7 and active signing area is also bordered by a change in surface texture or a slight change in surface height so as to provide tactile registration for operation by people with impaired vision.

The active signing area is textured to create a resistance against the tip 6 of the stylus 5, so recreating as closely as possible the sensation of using a normal pen on paper. The more familiar the signatory's experience, the more natural will be the execution of the signature. The texturing must be durable and scratch-resistant; it must not trap dust or skin particles; it must not discolour; it should not abrade the tip of the stylus excessively; it should not generate a static electrical charge; and it must be transparent, with good optical qualities. We have found that a textured surface can best be achieved by creating the texture in the material of the signing area as the signing area is formed. Our preferred materials are cast acrylic or cast polycarbonate with a fine front surface texture, typical of that used to achieve a medium anti-glare finish. Surface hardness of between 3H and 6H has been found to be ideal.

However, as an alternative it is possible to create a texture on the material of the signing area, already formed. We have found that in general abrading the surface is less successful than giving the surface a thin friction coating with a suitable second plastics material compatible with the material of the substrate, for example a softer material that is slightly tacky to the stylus tip or material having fine inclusions that enhance friction.

The hardness and elasticity of the stylus tip 6 is also important Hitherto, nibs have typically been made of acetyl; but though durable, the rigidity of the material yields an incorrect inertia profile. By contrast, we have found that polypropylenes, while sharing the virtue of durability, grip the surface in a more consistent manner, and have less influence on the acceleration and deceleration of the stylus 5 during the execution of a signature.

While we consider that for best results all the improved features of ergonomics should ideally be used together, significant improvements over the conventional prior art arrangements will still arise in embodiments in which the LCD 7 is omitted and the signing surface is opaque.

It will be apparent from the description above that the described apparatus embodies a number of important improvements over the prior art, in many cases novel in their own right

Thus: the addition to coordinate data packets of the kind sent out by previous signature capture devices of real-time information in the form of either absolute time or a sequential number allows signature analysis software to determine whether data packets have been lost or omitted by the data input system on the host system, and thus reconstruct more reliably the speed at which the pen was moving at any given point in the signature.

Inclusion in the control circuit of logic not only for testing the correct function of the various components, but for reporting the outcome of such testing to the host device permits the host device to maintain a log of self-test results, which greatly enhances the credibility of individual signature measurements reported by the apparatus.

Inclusion in the control circuit of logic for encrypting communications between itself and the host system prevents a would-be interceptor from misappropriating signature data and re-using them for some unauthorized purpose.

The LCD module may be designed so that the driver circuitry is offset to the bottom and side of the active signing area While, at first sight, this might seem an elementary solution, as explained above it has significant design advantages, and appears to be a solution that has eluded those skilled in this fast developing art despite the problem being reported in 1995.

Equipping the control circuit with a non-volatile memory containing a unique identifier by which the specific apparatus may be identified enables this identifier to be communicated to the host system and used to correlate signature data with self-test results, further strengthening their corroborative evidential effect In addition, the identifier may be associated with signature data and thus serve as evidence of the signatory's location.

By giving the surface of the active signing area a texture, and choosing the materials both of the signing surface and of the tip of the stylus so as to provide a degree of friction comparable with that experienced when using a normal pen on paper makes the signing process natural. Again, this may appear at first sight to be only a small step, but, as explained above, the problem has been appreciated since as long ago as 1994, and has not previously been solved.

Differentiating the surface texture of the surround and the horizontal arrangement of the active signing area enables visually impaired users more easily to locate the active signing area.

1. A method of reporting the writing motion of a hand, pen or stylus via a digital communications link, such reporting taking the form of packets of digital data, such packets containing position information, such packets also containing real-time information.

2. A method according to claim 1, wherein the real-time information takes the form of a digital encoding of the minute, second and fraction thereof, either separately or in combination.

3. A method according to claim 1, wherein the real-time information takes the form of a sequential number.

4. A method according to any preceding claim, wherein at least the position information is encrypted.

5. Apparatus for recording the movement of a stylus during handwriting, for example in the execution of a handwritten signature, the apparatus comprising:
digitizer means, capable of sensing the position of a stylus, and defining an active signing area; and
a control circuit capable of sampling at least orthogonal X and Y coordinates, in the plane of the active signing area, of a stylus in proximity to the said digitizer means, and of then transmitting information regarding said coordinates together with real-time information via a digital communications link, such real-time information being represented either as a sequential number or in absolute form as clock-time.

6. Apparatus according to claim 5, wherein the digitizer means is adapted to sense the point of writing contact between the stylus and the active writing area, and wherein the control circuit is adapted to sample X and Y coordinates of the point of writing contact.

7. Apparatus according to claim 5, wherein the digitizer means defines an active signing area, the location of which may be determined by touch.

8. Apparatus according to claim 7, wherein the location of the active signing area is indicated by a variation in texture.

9. Apparatus according to claim 7, wherein the location of the active signing area is indicated by a raised border.

10. Apparatus according to claim 7, wherein the location of the active signing area is indicated by a variation in surface height.

11. Apparatus for recording the movement of a stylus during handwriting, for example in the execution of a handwritten signature, the apparatus comprising:
digitizer means capable of sensing the position of a stylus, the digitizer device defining a signing area;
an LCD device having an LCD display substantially coextensive with the digitizer means and lying substantially in the same plane,
the LCD device having driver circuitry offset to the side of, and out of the plane of, the signing area; and
a control circuit capable of sampling at least orthogonal X and Y coordinates, in the plane of the active signing area, of a stylus in proximity to the said digitizer means.

12. Apparatus for recording the movement of a stylus during handwriting, for example in the execution of a handwritten signature, the apparatus comprising:
a stylus having a tip;
digitizer means capable of sensing the position of the stylus, the digitizer means defining a signing area;
an LCD device having an LCD display substantially coextensive with the digitizer means and lying substantially in the same plane; and
a control circuit capable of sampling at least orthogonal X and Y coordinates, in the plane of the active signing area, of the tip of the stylus in proximity to the said digitizer means;
the signing area being provided with a textured surface, the resistance of which to passage of the tip of the stylus thereacross is substantially the same as that of paper to passage of the tip of a pen or pencil thereacross.

13. Apparatus according to claim 11, wherein the LCD device is adapted to display the signature as written thereon in the form of electronic ink.

14. Apparatus according to claim 11, wherein the control circuit is adapted to transmit information regarding said coordinates together with real-time information via a digital communications link, such real-time information being represented either as a sequential number or in absolute form as clock-time.

15. Apparatus according to claim 5, wherein the digitizer means is adapted to detect stylus movements in a Z direction out of the plane of the active signing area in addition to the position of the stylus in the plane of the active signing area, and wherein the control circuit is adapted to sample X, Y and Z coordinates of the stylus and to transmit information regarding said coordinates via said communications link.

16. Apparatus according to claim 5, wherein the said coordinate information is encrypted prior to transmission via said digital communications link.

17. Apparatus according to claim 5, further comprising a control circuit adapted to verify correct operation of the digitizer means and to transmit such verification to a host system via a digital communications link.

18. Apparatus according to claim 5, wherein a unique identifier is associated with said apparatus, said identifier being stored in a non-volatile memory device, the apparatus being adapted to transmit the said unique identifier to a host device via a serial interface.

19. A system for recording handwritten signatures, comprising:
a host computer system; and
at least one peripheral devices, adapted to record signatures;
each of said at least one peripheral devices comprising an apparatus for recording the movement of a stylus during execution of a handwritten signature, which apparatus comprises:
digitizer means, capable of sensing the position of a stylus and defining an active signing area; and
a control circuit capable of sampling at least orthogonal X and Y coordinates, in the plane of the active signing area, of a stylus in proximity to the said digitizer means, and of then transmitting information regarding said coordinates together with real-time information via a digital communications link to said host computer, such real-time information being represented either as a sequential number or in absolute form as clock-time;
the control circuits of individual said peripheral devices each containing a non-volatile memory means incorporating an identifier for that peripheral device; and
each said control circuit (s) each being adapted to communicate its said identifier to said host computer together with said co-ordinates and said real-time information, whereby said host computer may identify both when and at which said peripheral device a particular signature was written.

20. A system according to claim 19, wherein at least said coordinate information is encrypted.

21. A system according to claim 20, wherein each said peripheral device includes a random number generator adapted on receipt of a pre-set signal to generate a random number encryption key for that peripheral device, the key so generated for the said peripheral device being required to be directly input into said host computer to allow the host computer to read coordinate information from said peripheral device.

22. A system according to claim 21, wherein said pre-set signal comprises the step of connecting operating power to said peripheral device.

23. A method of encrypting communication between a peripheral device and a host computer to which it may be connected, the method including generation of an encryption key for the said peripheral device by providing the peripheral device with a random number generator adapted on receipt of a pre-set signal to generate a random number encryption key for that peripheral device, the key so generated for the said peripheral device being required to be directly input into said host computer to allow the host computer to read data from said peripheral device.

24. A method according to claim 23, wherein said pre-set signal comprises the step of connecting operating power to said peripheral device.

25. Apparatus according to claim 14, wherein the digitizer means is adapted to detect stylus movements in a Z direction out of the plane of the active signing area in addition to the position of the stylus in the plane of the active signing area, and wherein the control circuit is adapted to sample X, Y and Z coordinates of the stylus and to transmit information regarding said coordinates via said communications link.

26. Apparatus according to claim 14, wherein the said coordinate information is encrypted prior to transmission via said digital communications link.

27. Apparatus according to claim 14, further comprising a control circuit adapted to verify correct operation of the digitizer means and to transmit such verification to a host system via a digital communications link.

28. Apparatus according to claim 14, wherein a unique identifier is associated with said apparatus, said identifier being stored in a non-volatile memory device, the apparatus being adapted to transmit the said unique identifier to a host device via a serial interface.
